(19) United States
(12) Patent Application Publication
(10) Pub. No.: US 2003/0081597 A1
(43) Pub. Date: May 1, 2003

(54) Dynamic buffering in packet systems

(76) Inventor: Martin Raymond Scott, Perranporth (GB)

Correspondence Address: MOSER, PATTERSON & SHERIDAN, L.L.P., Suite 1500, 3040 Post Oak Blvd., Houston, TX, 77056, US

(21) Appl. No.: 10/246,154

(22) Filed: Sep. 18, 2002

(30) Foreign Application Priority Data
Oct. 24, 2001 (GB) 0125612.2

(51) Int. Cl. H04L 12/50

(52) U.S. Cl. 370/378

(57) ABSTRACT

A method of writing data to a packet memory device in a system for transmitting data in packets across a packet network, wherein said packets are arranged to form a plurality of packet streams, the method comprising:

providing a plurality of buffers, each arranged to store data destined for said packets;

dynamically allocating to each packet stream a subset of buffers, wherein at any given time said subset comprises as many of said buffers as are currently required to store data destined for that packet stream;

writing to each subset of buffers data relating to the packet stream corresponding to that subset; and

transferring data from each subset of buffers to the packet memory device.

The invention relates to a method of writing data to a packet memory, and is particularly, although not exclusively, applicable to packet-TDM systems.

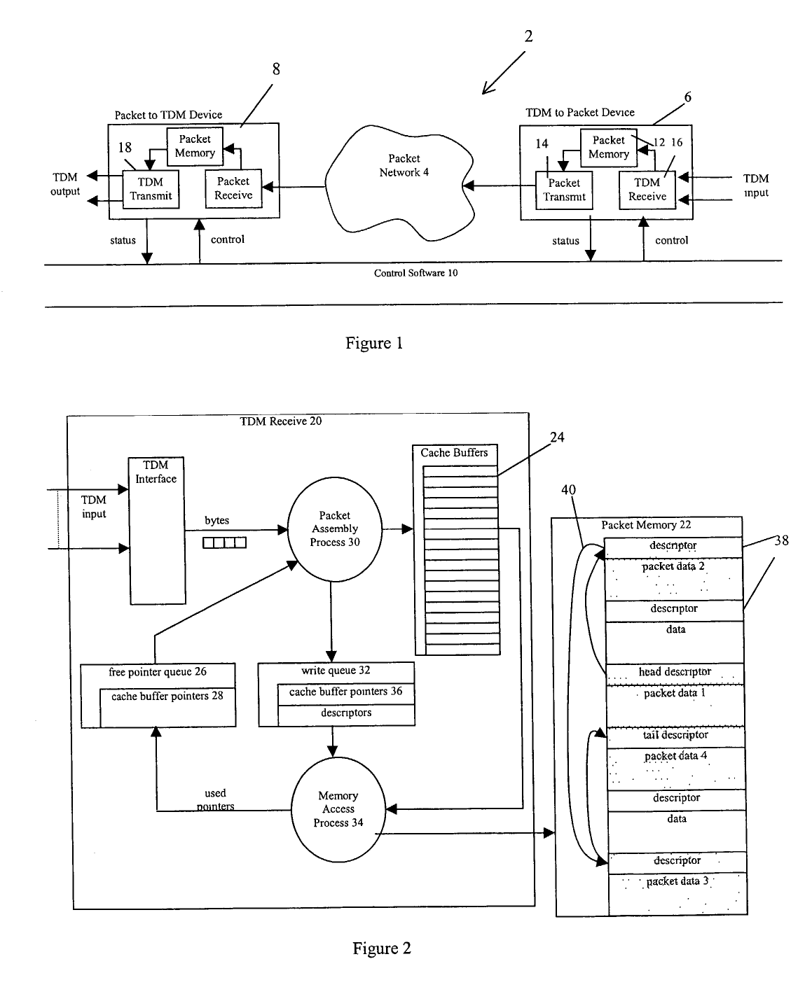

FIG. 1 shows schematically a known system that is used to transmit constant bit rate TDM data across a packet network 4, for example, so that it can be reconstructed as TDM data at the far end. The TDM to Packet Device 6 assembles incoming channels into packets. The Packet to TDM Device 8 performs the reverse function extracting channels from packets. Control Software 10 is required to set up and teardown connections, and to specify the mapping of channels into packets.

In the TDM to Packet Device 6, assembled packets are stored in a Packet Memory 12 prior to despatch by the Packet Transmit block 14. The Packet Memory 12 has a burst type interface, and a certain amount of latency is involved with accesses to it due to the fact that it is accessed by other blocks within the Device 6. That is, the Packet Memory 12 is shared.

The Devices can handle several active packet streams at a time, where each packet stream represents a “virtual channel connection” or “context” destined for a particular destination.

A context may contain a number of channels. Packets are assembled sequentially. Data is placed into the packet as it arrives at the TDM receive port 16, maintaining channel and stream order (i.e. channel 0, stream 0 comes before channel 0, stream 1, which comes before channel 1, stream 0).

The TDM Receive and Transmit blocks 16 and 18 map the stream and channel number from the TDM interface to a context number. This is accomplished using a lookup table. An example context lookup table for a small TDM environment with 4 streams each with 4 channels is shown below:

| Channel | Stream | Context |
|---|---|---|
| Number | Number | Identifier |
| 0 | 0 | 1 |
| 0 | 1 | 1 |
| 0 | 2 | 2 |
| 0 | 3 | 1 |
| 1 | 0 | 1 |
| 1 | 1 | 2 |
| 1 | 2 | 2 |
| 1 | 3 | 1 |
| 2 | 0 | 2 |
| 2 | 1 | 2 |
| 2 | 2 | 3 |
| 2 | 3 | 3 |
| 3 | 0 | 4 |
| 3 | 1 | 3 |
| 3 | 2 | 4 |
| 3 | 3 | 4 |

The mapping of TDM channels to packets is completely flexible, so that any combination of streams and channels can be mapped into a particular packet stream (context). Beause of this, some contexts may require a high bandwidth and others may require a low bandwidth. Also, some buffering is required in the TDM Receive block 16 in order to efficiently use the burst interface to the Packet Memory 12, and to accommodate access latency.

According to the invention there is provided a method of writing data to a packet memory device as set out in the accompanying claims.

The method allows buffers to be dynamically allocated to support the required bandwidth for a given context. The buffers can be allocated from a free pool of buffers that are available for use by any context. This avoids the necessity for each context to have its own pre-assigned buffers which would require many more buffers to ensure that any context could support the worst case where all channels were mapped to that context.

In addition the invention can provide support for a memory management scheme used within the device to control the transfer of packets into and out of the Packet Memory.

Specific embodiments of the invention will now be described, by way of example only, with reference to the accompanying drawings, in which:

FIG. 1 shows a known system for transmitting constant bit rate TDM data across a Packet network; and

FIG. 2 shows a modified TDM receive block and packet memory, forming part of a TDM to Packet device for use in a system such as that of FIG. 1.

The TDM Receive block 20 contains a number of cache buffers 24. The Packet Memory 22 has a burst type interface, so that in order to provide efficient access to the Packet Memory 22, the TDM Receiver 20 gathers the bytes destined for the same packet into a Cache Buffer 24 before despatch to the Packet Memory 22. The size of a Cache Buffer 24 is made equal to the size of the burst supported by the Packet Memory 22.

Each mapping of TDM channels to a packet (context) that exists concurrently will require one or more Cache Buffers 24. Furthermore, high bandwidth mappings require more Cache Buffers 24 than low bandwidth mappings, in order to accommodate the latency (i.e. time delay) involved with accessing the Packet Memory 22.

On initialisation, all Cache Buffers 24 are empty and available for use by any mapping, and a Free Pointer Queue 26 contains pointers 28 to each of the Cache Buffers 24. During operation a Packet Assembly Process 30 obtains empty Cache Buffers 24 by reading the pointers 28 from the Free Pointer Queue 26 as required. High bandwidth mappings automatically use more Cache Buffers 24 than lower bandwidth mappings.

When a Cache Buffer 24 is filled (or complete) the Packet Assembly Process 30 writes its pointer to a Write Queue 32. A Memory Access Process 34 reads pointers 36 to full Cache Buffers 24 from the Write Queue 32 and operates the interface to the Packet Memory 22 as fast as it is able in order to move data from the Cache Buffers 24 to Packet Memory 22. Once the Memory Access Process 34 has transferred the data from a Cache Buffer 24 to Packet Memory 22 it writes the now empty Cache Buffer pointer to the Free Pointer Queue 26 so that the Cache Buffer 24 can be reused by the Packet Assembly Process 30.

In order to facilitate memory management the Packet Memory 22 is divided into granules 38 which consist of a descriptor field and a data field. A packet may occupy one or more granules 38, depending on the size of the packet. Where a packet occupies more than one granule 38, the granules 38 within the packet are linked by means of the descriptor fields. Each descriptor field contains a pointer which holds the address of the next descriptor in the linked list. (These links are illustrated by the arrows 40 in FIG. 2, which shows an example packet made up by 4 granules). The TDM data is written into the data area of packet memory 22 by the Memory Access Process 34 as described above. Any writes to descriptor fields that are required are also written to the Write Queue 32 by the Packet Assembly Process 30. The Memory Access Process 34 recognises that these are descriptor writes as opposed to data writes, and writes the descriptor data contained in the write queue entry to Packet Memory 22.

The Free Pointer Queue 26 could be avoided by forming a linked list with the empty Cache Buffers 24, empty Cache Buffers 24 containing only a pointer to the next free Cache Buffer 24.

The invention is of benefit in any applications sending constant data over packet streams, where bandwidth requirements for concurrent data streams may vary dynamically, or where there is latency involved in accessing a shared memory.

1. A method of writing data to a packet memory device in a system for transmitting data in packets across a packet network, wherein said packets are arranged to form a plurality of packet streams, the method comprising:
providing a plurality of buffers, each arranged to store data destined for said packets;
dynamically allocating to each packet stream a subset of buffers, wherein at any given time said subset comprises as many of said buffers as are currently required to store data destined for that packet stream;
writing to each subset of buffers data relating to the packet stream corresponding to that subset; and
transferring data from each subset of buffers to the packet memory device.

2. A method as claimed in claim 1, which further comprises the step of maintaining a list of free buffers, which are available to receive data, and using buffers from said list of free buffers in said allocating step.

3. A method as claimed in claim 1 or 2, which further comprises the step of maintaining a list of data-containing buffers.

4. A method as claimed in any preceding claim, wherein data is placed in said buffers by a packet assembly process.

5. A method as claimed in claim 4, when also dependent directly or indirectly on claim 2, wherein said packet assembly process writes data to the buffer which is next in said list of free buffers.

6. A method as claimed in claim 4 or 5, when also dependent directly or indirectly on claim 3, wherein after writing data to a buffer, said packet assembly process adds a reference to the buffer to said list of data-containing buffers.

7. A method as claimed in any preceding claim, wherein data is transferred from the buffers to the packet memory device by a memory access process.

8. A method as claimed in claim 7, when also dependent directly or indirectly on claims 2 and 3, wherein said memory access process uses said list of data-containing buffers to select those buffers to be used in said transferring step, and said memory access process also updates said list of free buffers after transferring data to the packet memory device.

9. A method as claimed in claim 7 or 8, wherein said memory access process writes data to the packet memory device in a plurality of data granules, wherein granules relating to the same packet are linked to form a series of granules.

10. A method as claimed in claim 9, wherein each data granule contains a descriptor, and where data granules form a series of granules the descriptor contains the address of the next data granule in the series.

11. A method as claimed in claim 9, when also dependent directly or indirectly on claim 4, wherein said packet assembly process provides to the memory access process details of any writes which are required to descriptors.

12. A method as claimed in any preceding claim, wherein said packets are formed from TDM data.

13. A method as claimed in claim 12, wherein each stream of packets corresponds to a context in a packet-TDM system.
